(19) United States
(12) Patent Application Publication
(10) Pub. No.: US 2005/0187817 A1
(43) Pub. Date: Aug. 25, 2005

(54) Indicia display system and method

(76) Inventors: Timothy Francis Hall, The Colony, TX (US); Dwight David Harms, The Colony, TX (US)

Correspondence Address: KEVIN MARK KLUGHART, 2516 LILLIAN MILLER PARKWAY, SUITE 115, DENTON, TX, 76210-7205, US

(21) Appl. No.: 10/449,149

(22) Filed: May 30, 2003

Related U.S. Application Data
(60) Provisional application No. 60/384,937, filed on Jun. 1, 2002.

(51) Int. Cl. G06F 17/60

(52) U.S. Cl. 705/14

(57) ABSTRACT

An indicia display system and method incorporating removable and reusable indicia constructed of flexible fabric and/or plastic is disclosed. The present invention permits an indicia tag to be custom generated and then attached to a variety of indicia target displays by means of a non-metallic attaching means such as VELCRO® brand hook-and-loop fasteners or the like. This in conjunction with attaching means for each indicia target display permits a given indicia tag to migrate among various indicia target displays. This mobility permits a high degree of memorabilia migration and reuse while also permitting a safe environment for indicia to be uniquely generated to meet the needs of special events, sporting events, and the individual needs of sports athletes and their fans.

### CROSS REFERENCE TO RELATED APPLICATIONS

Applicant claims benefit pursuant to 35 U.S.C. § 119 and hereby incorporates by reference Provisional Patent Application for “INDICIA DISPLAY SYSTEM AND METHOD”, Ser. No. 60/384,937, docket TFH-2002-001, filed Jun. 1, 2002, and submitted to the USPTO with Express Mail on Jun. 1, 2002 with tracking number EU097923748US.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

As illustrated in FIG. 2 (0200), the present invention is related directly to use of indicia in a variety of display contexts and is particularly suitable for use in situations where sport team and/or athlete indicia is to be displayed in a variety of contexts. Various other contexts of indicia display generation systems embodying the invention concepts are illustrated in FIGS. 3-24.

### BACKGROUND OF THE INVENTION

As illustrated in FIG. 1 (0100), traditional indicia display systems involving sporting goods and the like have focused on the use of embroidered patches (0101) and the like that are either sewn directly onto sporting gear (hats, gloves, shoes, socks, etc.) (0110) or alternatively situations where embroidery is directly applied (0102) to a particular piece of sporting gear (0110).

These traditional methods do not permit any change of indicia once applied. A solution to this common problem has traditionally taken the form of the use of “indicia pins”, “lapel pins” (0103), and/or “campaign button” (0104) style removable indicia that comprise a faceplate and some form of pinning arrangement that either uses a lapel pin (and corresponding clasp) style of indicia or a metallic button having a pin-style clasp with a corresponding safety-pin or other pin-style clasping means.

Unfortunately, this solution to the removable indicia problem presents several insurmountable concerns in the context of modern day biological and terrorist threats. Firstly, the use of lapel and/or push-pin style indicia presents a safety issue for athletes in that the pins used to secure the indicia can accidentally puncture skin during use, and the metallic nature of the indicia can present a point of hard impact during vigorous contact sports.

Secondly, both lapel-pin/push-pin styles (0103) of removable indicia and campaign-style indicia contain sharp pin structures to affect connection. These sharp pins could be used as weapons either by terrorists or athletes and as such both of these types of indicia attachments have been banned by many sports organizations. Additionally, the metallic nature and sharp pins associated with these indicia make transportation of these items within secure areas (such as airports, courts, etc.) problematic if not impossible due to the inherent security concerns with the potential for the sharp pins and/or metal in these objects to be used as weapons.

Finally, the rampant increase in blood-borne diseases such as HIV/AIDS and Hepatitis-C precludes the introduction of any agent that might cause an athlete's skin to be compromised during sports activity. Thus, the use of indicia having sharp pins as indicated above is contra-indicated.

### DESCRIPTION OF THE PRIOR ART

Various U.S. patents have addressed some but not all of the issues cited above. Some relevant prior art in this area includes the following:

U.S. Pat. No. 4,776,043 issued to Richard E. Coleman on Oct. 11, 1988 for HAT AND LOGO that describes an improved hat with interchangeable patches that can be selectively attached to the hat. This patent describes a limited use hat with fixed text and replaceable patch indicia, and is too limited for general purpose indicia display.

U.S. Pat. No. 4,961,275 issued to Rita R. Klein on Oct. 9, 1990 for IDENTIFICATION BADGE that describes an identification badge designed to prevent a danger to delivery room patients. This invention has the drawback of requiring penetrating fasteners that are a safety concern in sporting environments.

U.S. Pat. No. 4,984,684 issued to John A. Connor and Dorothea H. Connor on Jan. 15, 1991 for AWARD-DESIGNATION APPARATUS FOR A GOLF CLUB BAG AND THE LIKE that describes an award-designation device that is permanently affixed to a golf bag and which is designed to interoperate with a clip or tack to permit affixation of an award designator to the golf bag. This invention has the drawback of requiring penetrating fasteners that are a safety concern in contact sporting environments.

U.S. Pat. No. 5,283,966 issued to Norman P. Rader, Richard C. Haug, and Peter C. Schellack on Feb. 8, 1994 for BADGE CONTAINING INTERCHANGEABLE FASTENERS that describes a badge including a badge plate and multiple and interchangeable means of fastening the badge to clothing or other items that are releasably attached. This invention includes a clip attaching means, a pair of military style pins, an alligator clip, and a horizontal pin or magnet, all of which present safety concerns when used in a sporting goods environment.

U.S. Pat. No. 5,813,153 issued to Francesco Maglio on Sep. 29, 1998 for METHOD AND APPARATUS FOR TRACKING GARMENTS that describes a method and device for identifying and tracking garment and accessories in order to avoid repeating in wearing of the same garment and accessories to the same social function in its next occurrence. This invention includes a clip attaching means that presents safety concerns when used in a sporting goods environment.

U.S. Pat. No. 6,339,866 issued to Vaughn French on Jan. 22, 2002 for METHOD AND APPARATUS FOR A REMOVEABLE NAMETAG OR INSIGNIA that describes removable nametag or insignia that is placed on a uniform or garment with a hook-loop system like the product sold under the registered trademark VELCRO@. This invention limits the discussion to shirt insignias, and also limits the scope of method to the use of displaying name or rank within the context of a shirt.

U.S. Pat. No. 6,484,424 issued to James Peterson on Nov. 26, 2002 for VERSATILE BADGE PLATE WITH A JEWELRY-LIKE APPEARANCE that describes a low-cost assembly providing for a do-it-yourself display of graphic material while enabling a user to employ modern devices for generating the graphics. This invention includes a pin attaching means that presents safety concerns when used in a sporting goods environment.

U.S. Published patent application 2002/0152650 with inventor Robert J. Reeves published on Oct. 24, 2002 for MAGNETIC NAME PLATE ASSEMBLY AND CONNECTOR THEREFOR that describes a name plate assembly including a name plate and a connector which are magnetically attracted to each other and which are disposed on opposite sides of a piece of clothing during use. This invention includes a metallic attaching means that presents safety concerns when used in a sporting goods environment.

### OBJECTIVES OF THE INVENTION

Accordingly, the objectives of the present invention are (among others) to circumvent the deficiencies in the prior art and affect the following objectives:
(1) To provide a system and method permitting removable indicia to be safely attached and displayed to a variety of sports and/or other recreational memorabilia.
(2) To eliminate the safety concerns associated with traditional indicia display systems.
(3) To reduce the cost of indicia display system by permitting the indicia itself to migrate to a variety of contexts.
(4) To create marketing avenues for sports memorabilia, by which the present invention would represent or be memorabilia, marketing tools, collector items, special events notifications, celebrations, achievements, or any other items that may be purchased, sold, disseminated, given away, traded or collected.
(5) To permit automation of indicia in the sports memorabilia arena, permitting custom indicia to be generated and traded.
(6) To permit access to high quality custom indicia manufacturing to the average consumer.
(7) To integrate custom graphics with licensed artwork for the purposes of creating custom indicia that are tailored to the needs of the sports enthusiast.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention as generally illustrated in FIG. 2 (0200) and permits an indicia collector (0201) to operate a computer system (0202) for the purposes of generating an indicia label (0203) that is applied to an indicia tag (0204). This indicia tag (0204) is then applied using a removable adhesive means such as VELCRO® brand hook-and-loop fasteners or the like to a variety of indicia target displays (0210) such as gloves, caps, visors, sweat bands, shoes, jackets, clothing, sports equipment, storage cases, presentation cases, etc.

The basic concepts of the invention as illustrated in FIG. 2 may also be embodied in a wide variety of other systems and methods, examples of which are illustrated in FIGS. 3-24. Note particularly that the computer system (0202) and associated software may be distributed in a networked environment as illustrated in FIGS. 9, 21, and 22. In general, the teachings of the present invention are applicable to use in a distributed networked computer environment with no loss of generality.

### BRIEF DESCRIPTION OF THE DRAWINGS

For a fuller understanding of the advantages provided by the invention, reference should be made to the following detailed description together with the accompanying drawings wherein:

FIG. 1 illustrates the prior art as applied to indicia management systems and application methods and display methods;

FIG. 2 illustrates a typical system embodiment of the present invention;

FIGS. 3-6 illustrate a typical system embodiment of the present invention as applied to baseball gloves;

FIG. 7 illustrates a typical method embodiment of the present invention;

FIG. 8 illustrates a typical method embodiment of the present invention as applied to the fabrication of the indicia tags;

FIG. 9 illustrates an exemplary embodiment of the present invention as embodied in an exemplary custom indicia generation system and method;

FIG. 10 illustrates an exemplary embodiment of the present invention as embodied in an exemplary stock article selection process;

FIG. 11 illustrates an exemplary embodiment of the present invention as embodied in an exemplary indicia trading system and method;

FIG. 12 illustrates an exemplary embodiment of the present invention as embodied in an exemplary indicia generation process;

FIG. 13 illustrates an exemplary embodiment of the present invention as embodied in an exemplary customer interface process;

FIG. 14 illustrates an exemplary embodiment of the present invention as embodied in an exemplary e-commerce process;

FIG. 15 illustrates an exemplary embodiment of the present invention as embodied in an exemplary vendor selection process;

FIG. 16 illustrates an exemplary embodiment of the present invention as embodied in an exemplary stock target consumer selection process;

FIG. 17 illustrates an exemplary embodiment of the present invention as embodied in an exemplary indicia output process;

FIG. 18 illustrates an exemplary embodiment of the present invention as embodied in an exemplary embodiment of an indicia construction process;

FIG. 19 illustrates an exemplary embodiment of the present invention as embodied in a vendor custom indicia coupon system;

FIG. 20 illustrates an exemplary embodiment of the present invention as embodied in a vendor custom indicia coupon method;

FIG. 21 illustrates an exemplary embodiment of the present invention as embodied in an exemplary indicia registration system;

FIG. 22 illustrates an exemplary embodiment of the present invention as embodied in an exemplary indicia registration/trading system;

FIG. 23 illustrates an exemplary embodiment of the present invention as embodied in an exemplary indicia display/collection/trading system;

FIG. 24 illustrates an exemplary embodiment of the present invention as embodied in an exemplary indicia display system incorporating a hat as the display backdrop for single or multiple custom indicia.

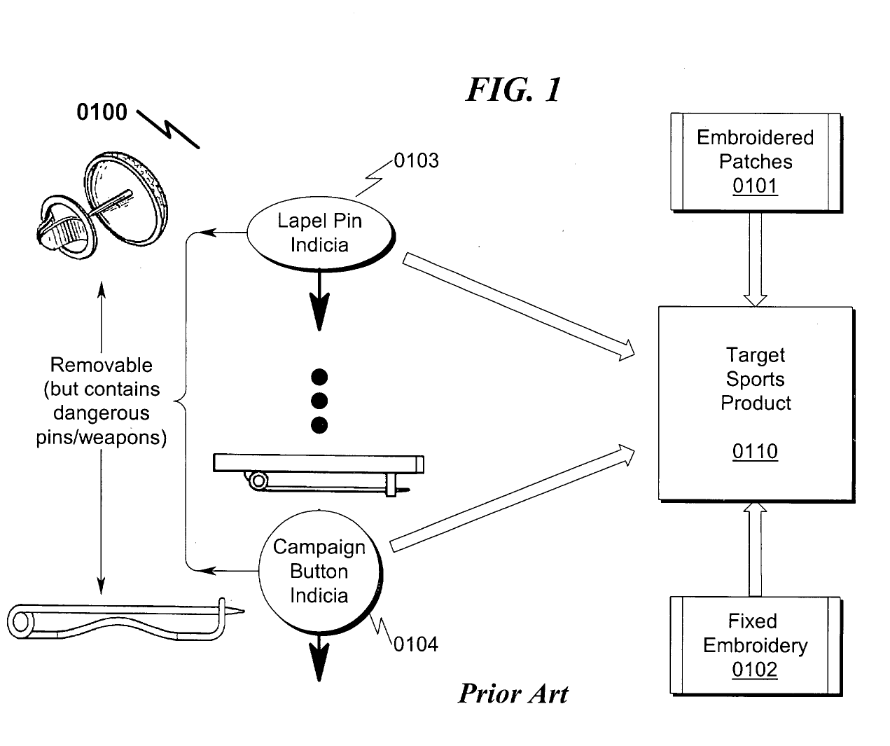

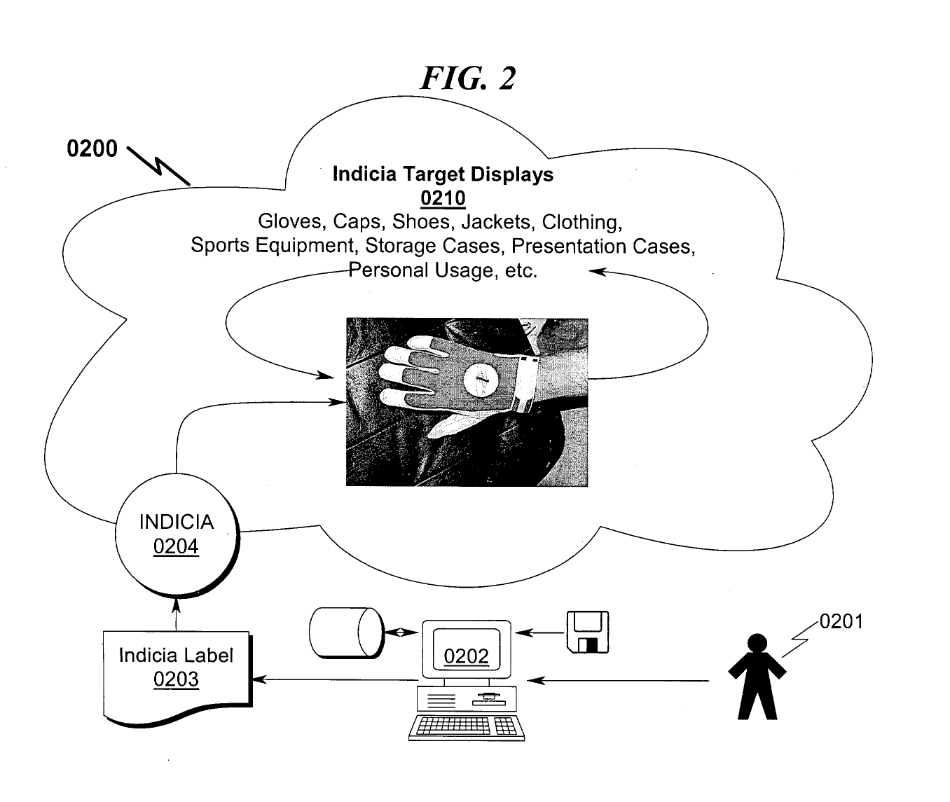

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a INDICIA DISPLAY SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### VELCRO® Not Limitive

Within the context of the present invention disclosure, the use of a hook-and-loop fabric mating system, such as the trademarked VELCRO® brand hook-and-loop system is discussed. The present invention is not limited to this particular fabric hook-and-loop system, and other similar technologies known to one skilled in the art are also acceptable in this context. Note also that the indicia generated by the present invention may be attached to the “hook” material component of a VELCRO® brand hook-and-loop system or its equivalent, and the mating component material (“loop”) may comprise other mating materials such as polyester tricot or the like.

### Exemplary System Embodiment (0300, 0400, 0500, 0600)

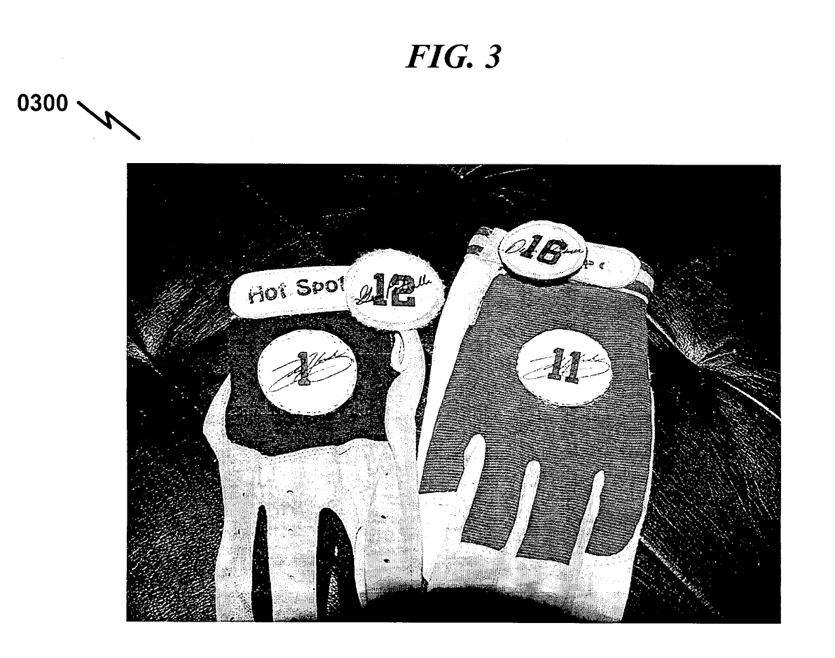

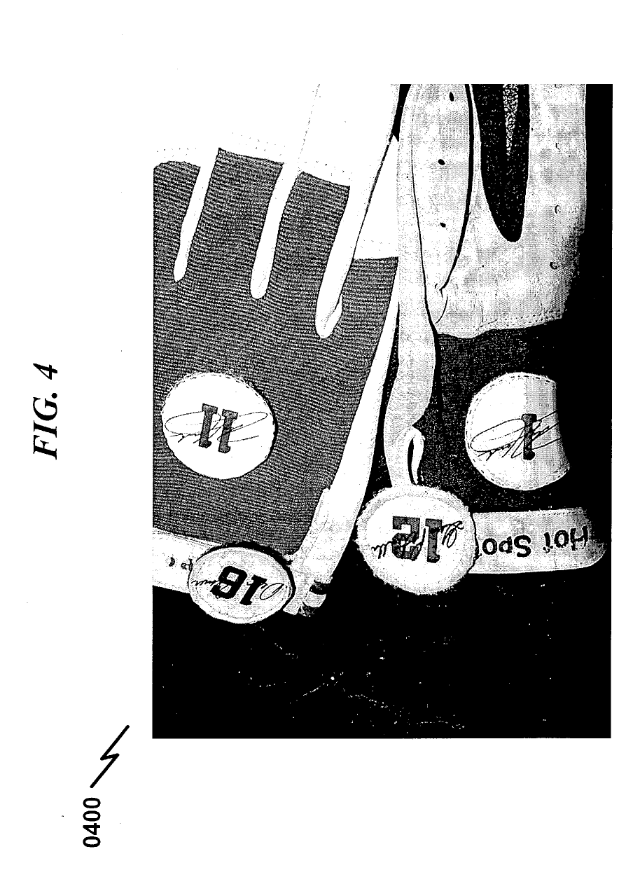

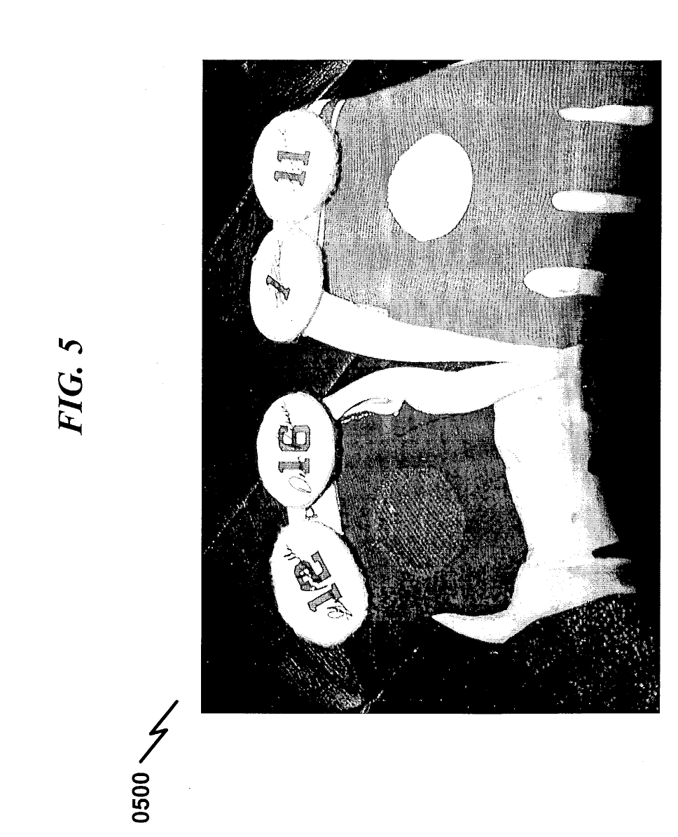

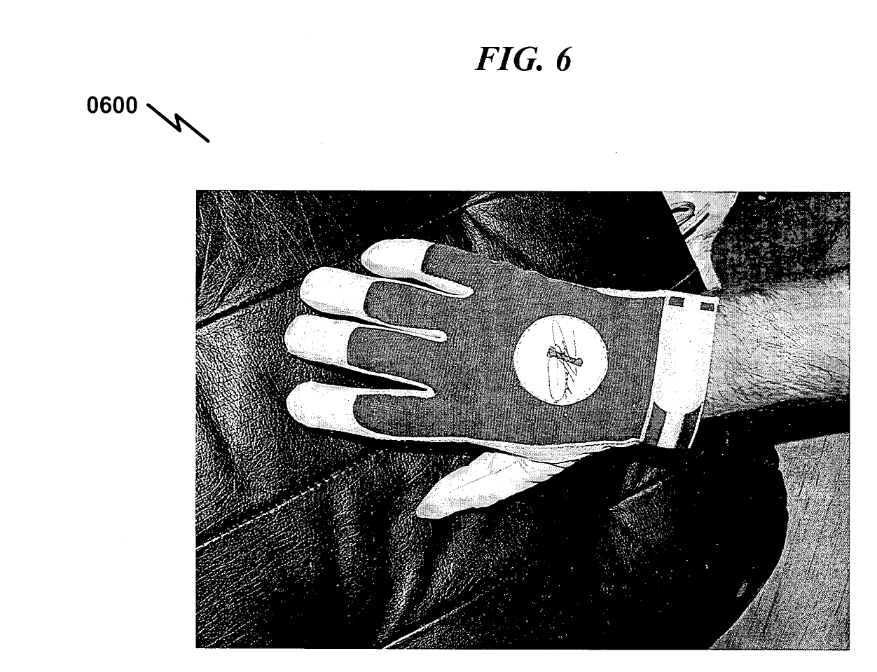

As generally illustrated in FIGS. 3-6 (0300, 0400, 0500, 0600), the present invention can generally be described as a one or optional two-piece system that would allow some forms of indicia (that consists of but not limited to description, image, text, photograph, sound, computer transferable technology, both digital and/or analog) to be purchased, sold, disseminated, displayed, collected, traded or any other action a person, business or entity may require. This system can represent or actually be memorabilia. The present invention allows a single system to integrate various items of interest (memorabilia), which would transcend across the infinite aspects of a persons lifestyle, thus establishing a one to many relationship.

The one piece indicia system consists of an object of various polygonal shapes (both regular and irregular) and sizes made from plastic, metal, cloth, paper or any other element or compound which could be but not limited to written, drawn, silkscreen, photocopied, etched, printed or copied upon. For the purposes of this description we will consider a round object and call it a disc, which would be in various diameters. The front would have the indicia to be represented and the back would have some type of adhesive agent, which could be but not limited to VELCRO® brand hook-and-loop fasteners or the like, glue, sealants, sewing, bonding cement. This agent would not be any pin, needle, sharp-faced object that could be used as a weapon. In this preferred embodiment, the disc would then be mated with any one of a number of objects, which would have the proper mating adhesive.

The two-piece system would consist of the indicia part of the one-piece system and an intermediate piece, which could be of various polygonal shapes (both regular and irregular) and composed of but not limited to plastic, metal, cloth, paper or any other element or compound. This second piece could be affixed to various objects and then the mating indicia part would be affixed to it. The affixing will be as described as above.

### Exemplary System Application—Baseball Batting Glove

An exemplary embodiment of the present invention is illustrated as applied to a baseball glove in FIGS. 3-6 (0300, 0400, 0500, 0600). A player or team could have his/her own disc and could choose to give or sell as an autograph. Other possible examples include certain discs given out at the World Series. Then, for example, consider the case in which something spectacular happens during that Series. Only people that attended the game would have the original discs. This would add to the value of that disc.

Also possible using this system are situations supporting young children that play in various leagues of baseball. They may want to have their number, or a disc that would represent their team, and if they won their championship, they may want an additional disc to represent the championship game.

The disc does not have to be limited to just gloves. It is possible to also consider caps with several areas of adhesion. Consider the case in which a baseball fan has several teams and/or players he may wish to support. He/She could have one cap with several different discs and should one player or team would fall out of favor they could easily be replaced by another.

In addition to affixing indicia to gloves and hats they could be affixed to other articles of clothing such as jackets, shirts, pants, shoes, dresses, or any other article the person may wish.

The same could be said for other sports such as Golf, Tennis, Bowling, Motor or Engine Powered Sports, Football, Running, Hunting, Fishing, Soccer, Hockey, Lacrosse, Rugby, Snow Skiing, Swimming, Diving, SCUBA Diving, Track and Field Events, and any other sport that would have indicia or other memorabilia.

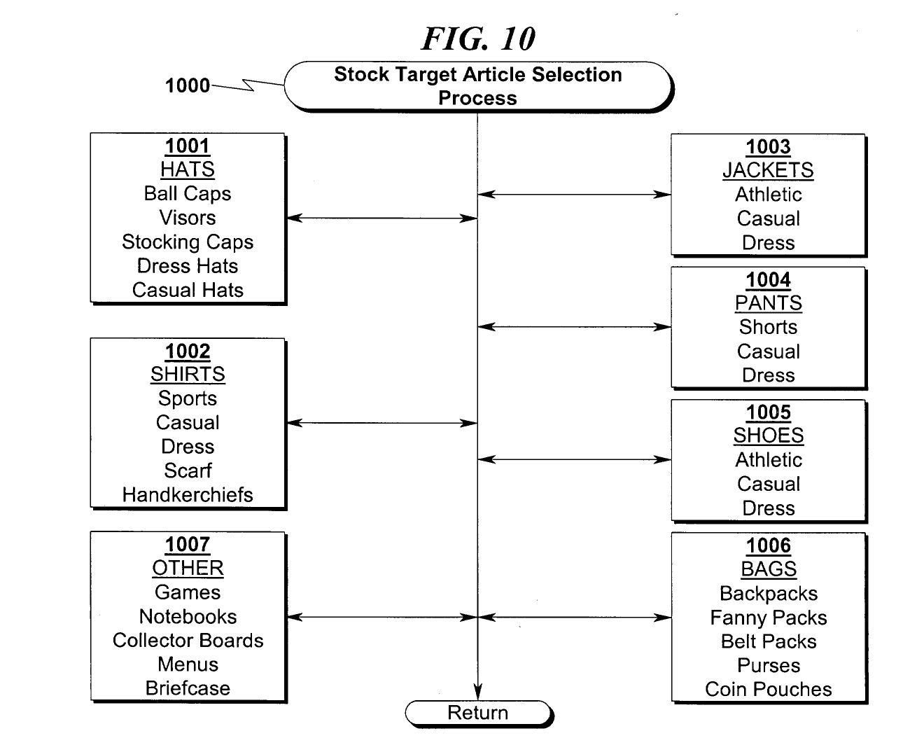

Also indicia could be attached to any applicable equipment like but not limited to tennis rackets (on the handle end), or a golf club handle. FIG. 10 (1000) illustrates some exemplary applications of the present invention (1001, 1002, 1003, 1004, 1005, 1006, 1007).

### Exemplary System Application—Special Events (1628)

Not only could these be related to sports they could be done for just about anything a person would want to collect, notify, etc.

For example, suppose there was a national event such as first spacecraft to land on Mars. In this case it would be easy to manufacture discs to celebrate the event.

With low manufacturing costs these could be made available for personal or group events. An example might be a local high school or middle school band wins a competition, or the debate team wins a district debate, a school celebrates it's 25^{th} year of helping students learn, the varsity team or band wins a competition, etc.

### Exemplary System Application—Business (1626, 1627)

Any business could use this as a promotional item, to do anything from introduce their company or promote a new product or celebrate a significant achievement. Some may want to use it to recognize an employee for a special contribution to the company's success.

Business could also use this as a replacement for the current visitor badge. An example might be a person's driver's license which could be downloaded and displayed on a badge made of downloadable material.

### Exemplary System Application—Entertainment (1614)

A person may collect favorite movie discs, or a favored music group concert disc. Perhaps someone may wish to have memorabilia for a musical or drama performance. This might include a collection of favorite movie stars.

### Exemplary System Application—Political/Governmental (1615)

Armed forces may wish to have a certain display or insignia that may change with a person's rank.

At political conventions this would offer a safe alternative to a campaign button or insignia of ones party affiliation or some other political aspect.

The government may have a time it wishes to commemorate a certain event.

### Exemplary System Application—Accessory Products

Consider the example in which someone is collecting discs. They would surely need a special case or something to save and display them in. Just as in baseball cards or coin collecting it is possible have all sorts of ancillary devices a person would need to aid in the collection and trading.

### Safety and Health Benefits

As the systems will not be using pins or other sharp objects to adhere the memorabilia (either in the one or two-piece system) the safety concerns associated with using pins (like hat pins or lapel pins) will be eliminated. With the great concern today concerning the transmittal of disease like AIDS this will offer a much safer alternative and yet still have expression of ones interest or concern.

Also with the recent awareness of how even small sharp objects could be considered a terrorist weapon this system would eliminate that possibility yet still allow creative expression.

### Potential Industries (Domestic and International)

The following illustrate a small number of anticipated potential industrial applications (Domestic and International) associated with the present invention:
Sports
Recreational
Entertainment
Commerce/Business
Education
Religious
Scientific
Government
Current Events
   One skilled in the art will no doubt expand this exemplary list given the teachings of the present invention.

### Exemplary Activities Associated with the Present Invention

The following illustrate a small number of anticipated potential activities associated with the present invention:
Autographs (1614)
Identification (1616)
Personal Usage (1617)
Fund Raisers (1623)
Collection (1624)
Marketing/Advertising (1627)
Events (1628)
Celebrations (1628)
   One skilled in the art will no doubt expand this exemplary list given the teachings of the present invention.

### Exemplary Products Associated with Present Invention (1000)

The following illustrate a small number of anticipated potential products associated with the present invention:
Gloves
Caps
Shoes
Jackets
Clothing
Sports Equipment
Personal Usage
Storage cases
Presentation cases
   One skilled in the art will no doubt expand this exemplary list given the teachings of the present invention.

### Exemplary System Architecture (0900, 1000)

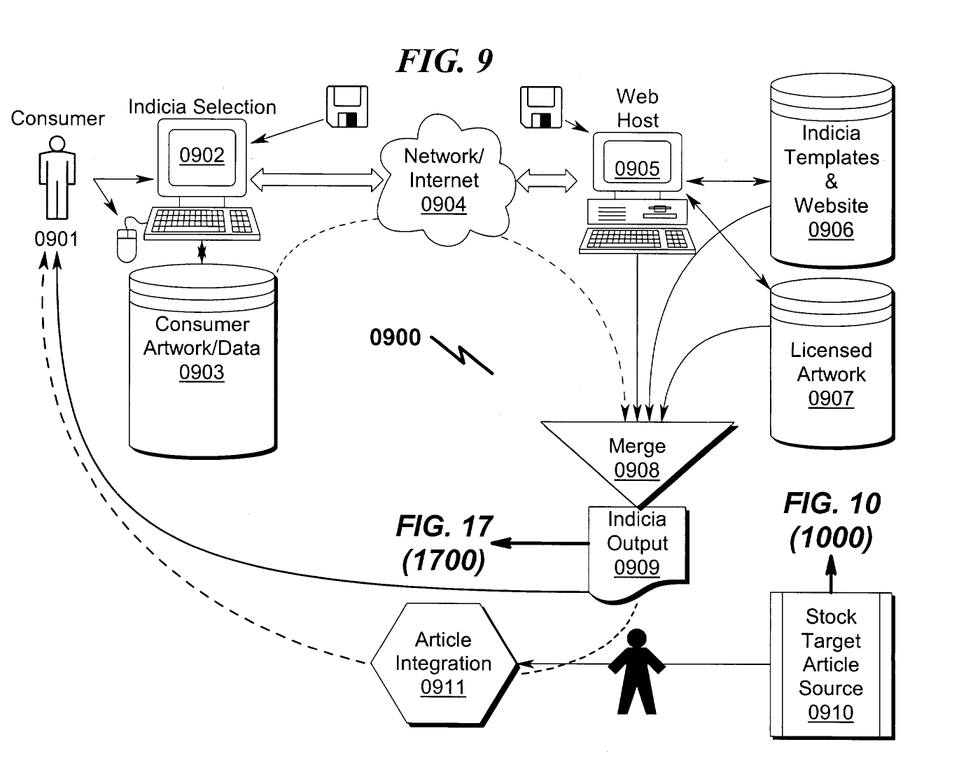

A typical system embodiment of the present invention as applied to custom indicia generation is illustrated in FIG. 9 (0900). This system embodiment illustrates a typical environment in which a consumer (0901) desires to obtain an indicia, optionally connecting this indicia to a target article. Here the consumer (0901) interacts with a computerized display device (0902) to generate artwork and/or data (0903) describing the indicia characteristics.

This indicia selection station (0902) may optionally communicate via a network and/or the Internet (0904) to a host computer (0905) that has access to standardized indicia templates (0906) and/or licensed artwork (0907). For example, the consumer (0901) may wish to integrate the picture of a professional athlete with other logos or artwork for a local amateur sports team. The availability of licensed artwork (0907) in conjunction with stock indicia templates (0906) permits such integration. Information from these sources (0903, 0906, 0907) is then merged (0908) to form the indicia artwork and is then output on the target indicia material (0909). Preferred embodiments of the present invention make use of ADOBE ILLUSTRATOR® available from ADOBE SYSTEMS, INC., and FLEXI-SIGN PRO available from FLEXI-TOOLS to provide the merging/editing functions for the indicia prior to output on the target material, but one skilled in the art will recognize that other commercially available software may be also be suitable in this application.

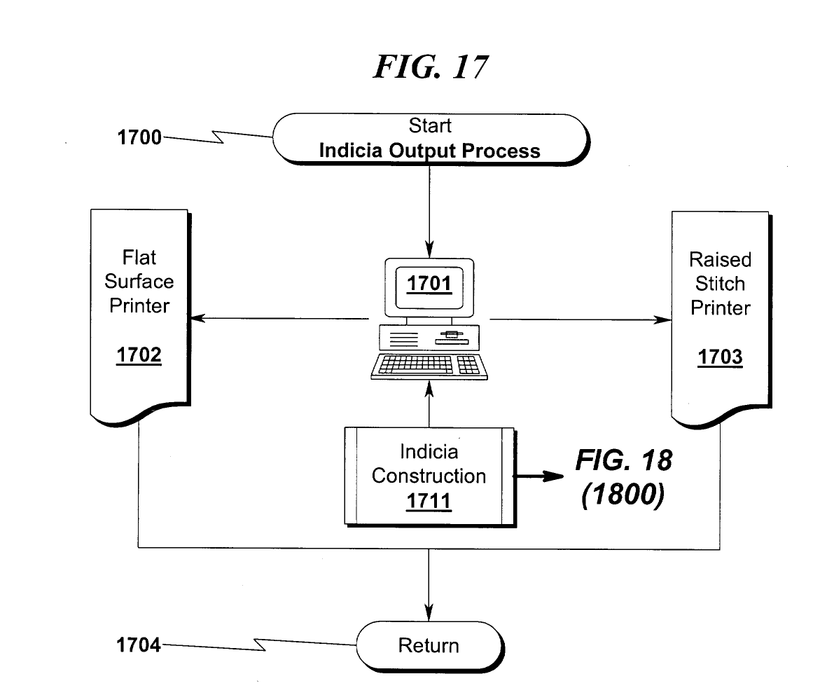

Note that a variety of indicia output materials are available, from flat surface printers to raised stitch printers, plotters, and the like. One skilled in the art will quickly realize that there are a wide variety of output methodologies available to implement the indicia output process detailed as (0909). Some of these are illustrated in FIG. 17 (1700), and include computer controlled (1701) flat surface printers (1702) and raised stitch printers (1703). A preferred embodiment of the present invention uses a Roland PC600 digital plotter/scanner/cutter as a suitable flat surface printer (1702) in this application.

Once the indicia has been fabricated/printed (0909), it may then be directly transferred from the indicia manufacturer to the ultimate consumer (0901), or it may be integrated with stock target articles (0910). As illustrated in FIG. 10 (1000), these target articles may include hats (ball caps, visors, stocking caps, dress hats, casual hats, etc.) (1001), shirts (sports, casual, dress, scarves, handkerchiefs, etc.) (1002), jackets (athletic, casual, dress, etc.) (1003), pants (shorts, casual, dress, etc.) (1004), shoes (athletic, casual, dress, etc.) (1005), bags (backpacks, fanny packs, belt packs, purses, coin purses, etc.) (1006), and other articles (games, notebooks, collector boards, menus, briefcases, etc.) (1007).

### Exemplary Trading Architecture (1100)

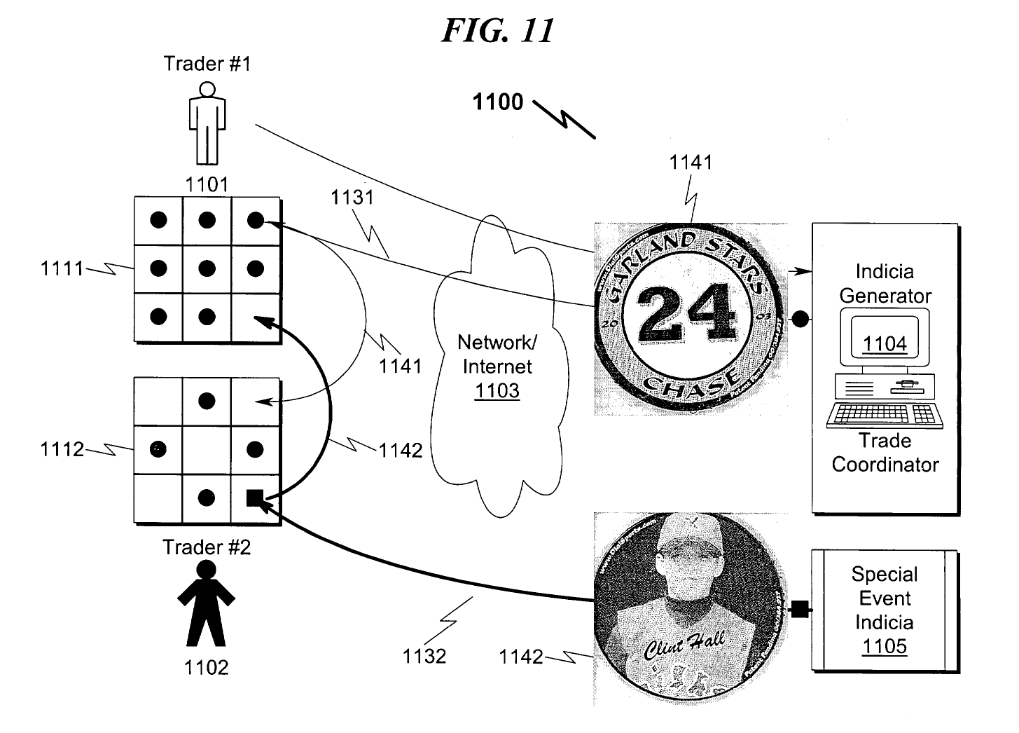

The exemplary indicia generation system illustrated in FIG. 9 (0900) and FIG. 10 (1000) may be used within the context of an indicia trading architecture as illustrated in FIG. 11 (1100). Here one or more traders (1101, 1102) may interact via a network (1103) with an indicia generation system (1104) to obtain an indicia (1131) for placement in an indicia collection (1111). This indicia collection (1111) may include a special indicia display board in some embodiments or in some embodiments a collectable memorabilia board.

In some embodiments traders (1102) may obtain special events indicia (1105) that may be generated at or for special events, such as special sporting events. One example of this might be commemorative indicia generated for special sporting events, or indicia generated by specific athletes in conjunction with a given sporting season. Prior art permitted sports fans to collect baseball cards and the like associated with specific players and teams, while the present invention permits the collection of indicia targeting these same athletes, with a primary advantage being that the indicia can be worn by the collector on a wide variety of clothing.

In these trading situations, one trader (1101) can trade (1141) indicia (1131) obtained from the indicia generator/trade coordinator (1104) with a cooperating trader (1102). This trading may either occur as a result of cooperation with the indicia generator/trade coordinator (1104) via some network connection (1103), or may occur directly with the cooperating trader (1102). Note this scenario anticipates that special events indicia (1105) may be traded (1142) by one trader (1102) to a cooperating trader (1101) to complete the indicia collection (1111) of the cooperating trader (1101). The use of cooperating trading (1141, 1142) permits optimal completion of the indicia collections (1111, 1112) of each cooperating trader (1101, 1102).

The use of the indicia generator (1104) and/or the network/Internet (1103) to permit cooperative trading permits both the on-demand generation of indicia based on consumer demands as well as facilitating the dispersal of these indicia to cooperating traders. A wide variety of scenarios are possible, but some common themes are as follows:
Traders who are local to various sports teams may trade indicia with others outside the locale of the sports team.
Amateur athletes may trade indicia for their teams, including but not limited to custom indicia with their names, to friends and family.
A wide variety of special events, such as concerts and the like, could promote their activities via the use of custom event indicia. This might even include personalization of indicia for a given event, such as “John Doe survived Woodstock 2010!”. The on-demand nature of the indicia generation process permits even pictures of individuals to be incorporated within the finished indicia (FIG. 11, (1142)), thus permitting a wide variety of custom artistic effects to be generated within a standard indicia generation framework.

Other scenarios are possible, and those listed above are illustrative of only some possibilities, and not limitive of the scope of the invention.

### System Variations

The present invention anticipates a wide variety of variations in the basic theme of construction. The examples presented previously do not represent the entire scope of possible usages. They are meant to cite a few of the almost limitless possibilities.

### Exemplary Display Method (0700)

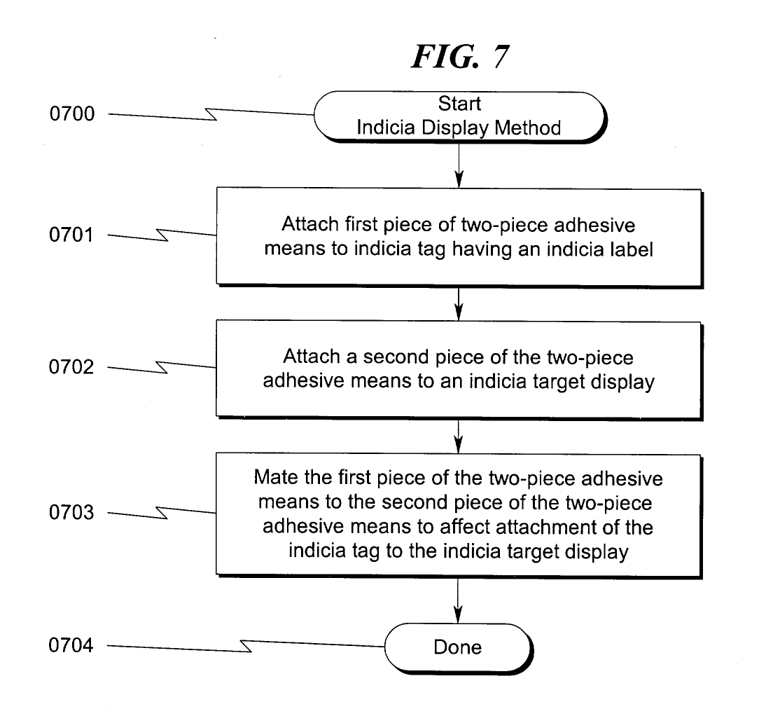

FIG. 7 (0700) illustrates a typical implementation of the disclosed indicia display method. Here the process generally consists of the following steps:
Attaching the first piece of two-piece adhesive means to indicia tag having an indicia label (0701);
Attaching a second piece of the two-piece adhesive means to an indicia target display (0702);
Mating the first piece of the two-piece adhesive means to the second piece of the two-piece adhesive means to affect attachment of the indicia tag to the indicia target display (0703).

One skilled in the art will realize that this method may be augmented with steps to affect a wide variety of artistic effects using the disclosed indicia display method.

### Exemplary Indicia Tag Fabrication Method (0800)

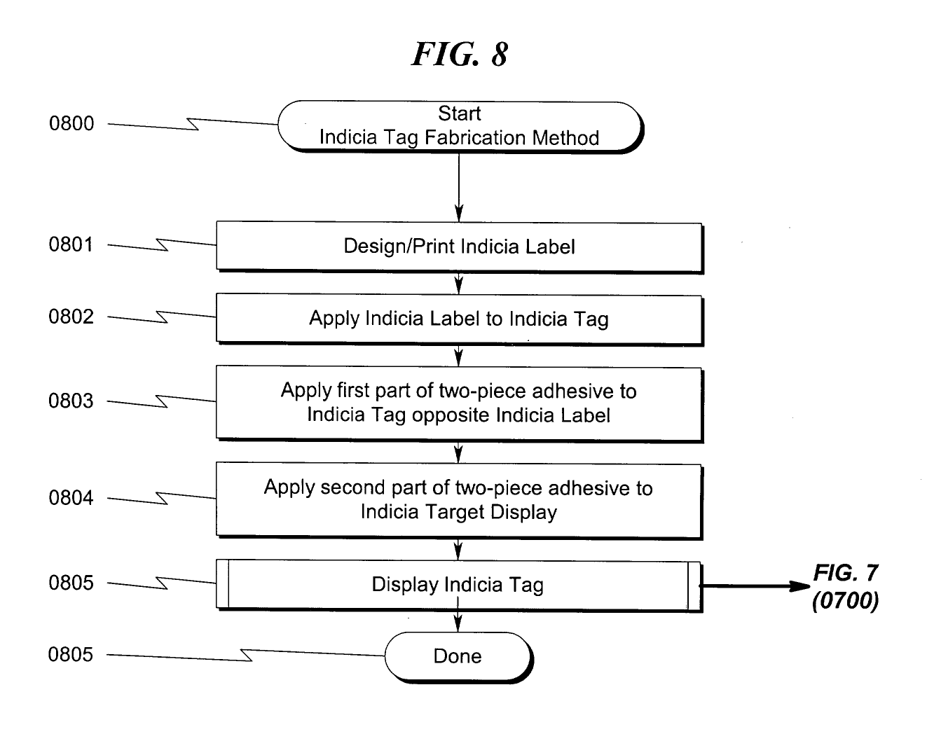

FIG. 8 (0800) illustrates a typical implementation of the disclosed indicia tag fabrication method. Here the process generally consists of the following steps:
Designing/Printing the Indicia Label (0801);
Applying the Indicia Label to Indicia Tag (0802);
Applying the first part of two-piece adhesive to Indicia Tag opposite Indicia Label (0803);
Applying the second part of two-piece adhesive to Indicia Target Display (0804);
Displaying the Indicia Tag (0805). This optional process step is further detailed in FIG. 7 (0700).

One skilled in the art will realize that this method may be augmented with steps to affect a wide variety of artistic effects using the disclosed indicia display method.

### Exemplary Indicia Generation Method (1200)

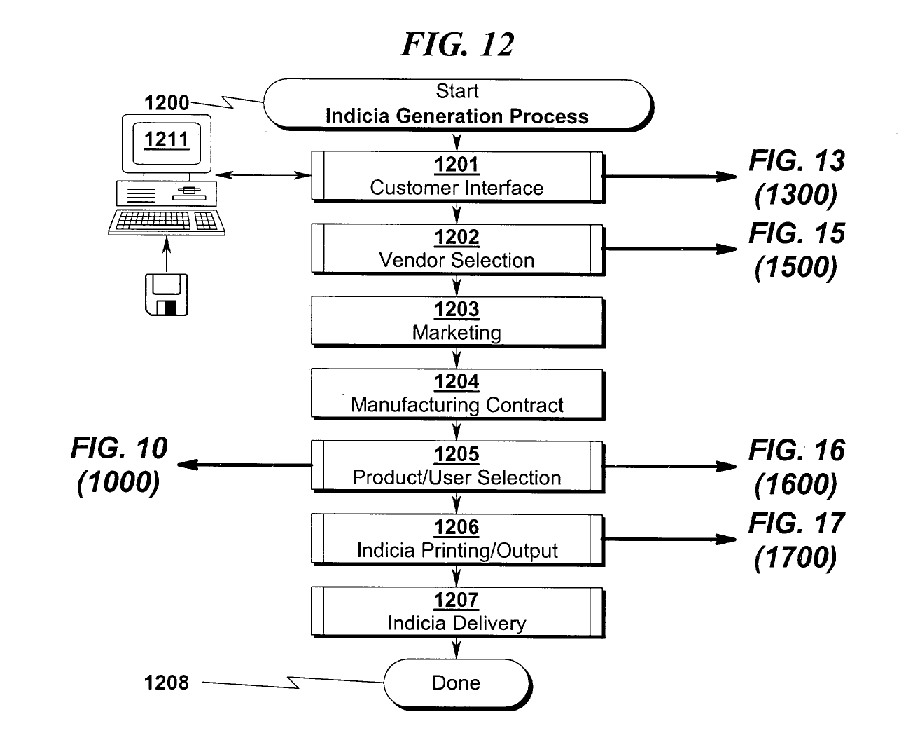

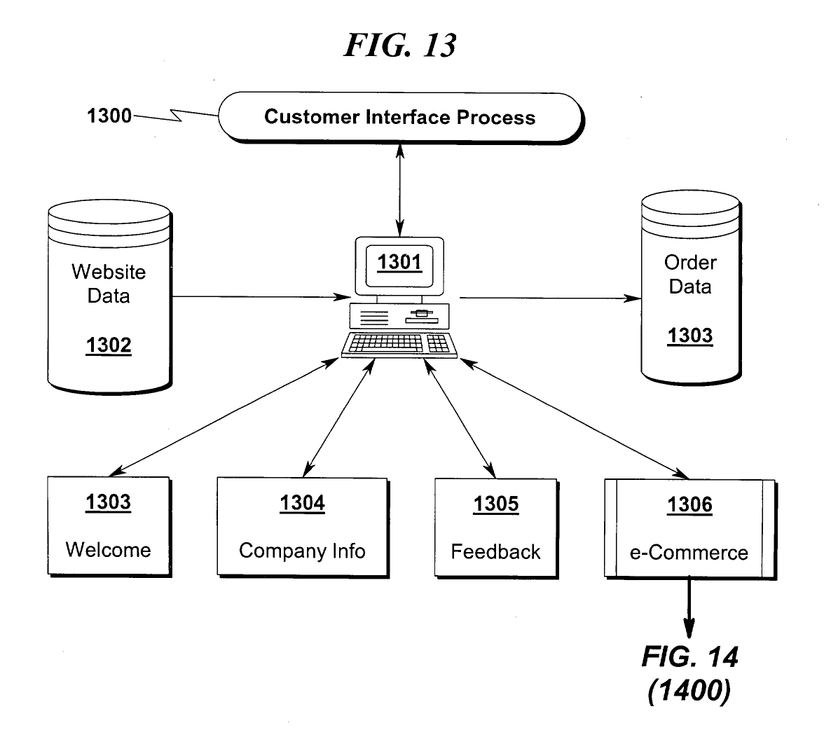

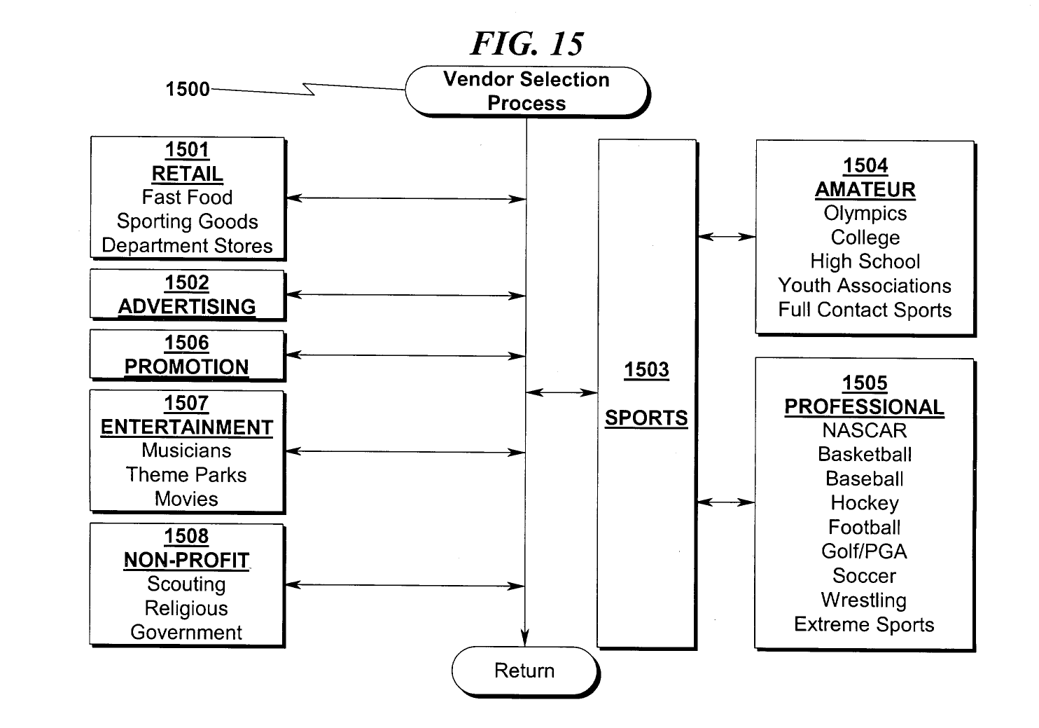

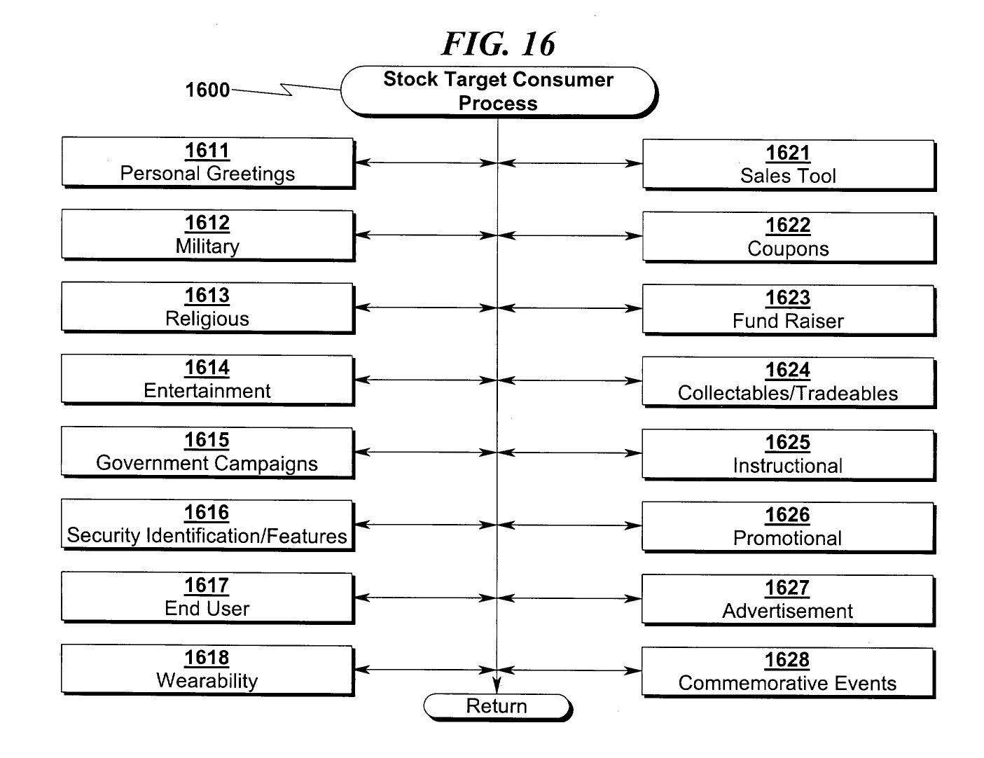

FIG. 12 (1200) illustrates a typical implementation of the disclosed indicia generation method. Here the process generally consists of the following steps:
Providing a computer controlled (1211) customer interface (1201). This process step is further detailed in FIG. 13 (1300).
Selecting the appropriate vendor (1202). This process step is further detailed in FIG. 15 (1500), and may include retail (1501), advertising (1502), sports (1503) including amateur (1504) and professional (1505), as well as promotions (1506), entertainment (1507), and non-profit (1508) vending outlets, among others.
Optionally providing marketing for the indicia (1203).
Optionally obtaining a manufacturing contract for the indicia (1204).
Selecting a target/product/consumer for the indicia (1205). This process step is further detailed in FIG. 10 (1000) and FIG. 16 (1600).
Creating the indicia using a computerized manufacturing process (1206). This process step is further detailed in FIG. 17 (1700).
Delivering the indicia to the end-user customer (1207).

One skilled in the art will realize that this method may be augmented with steps to affect a wide variety of artistic effects using the disclosed indicia display method.

### Exemplary Customer Interface Method (1300, 1400)

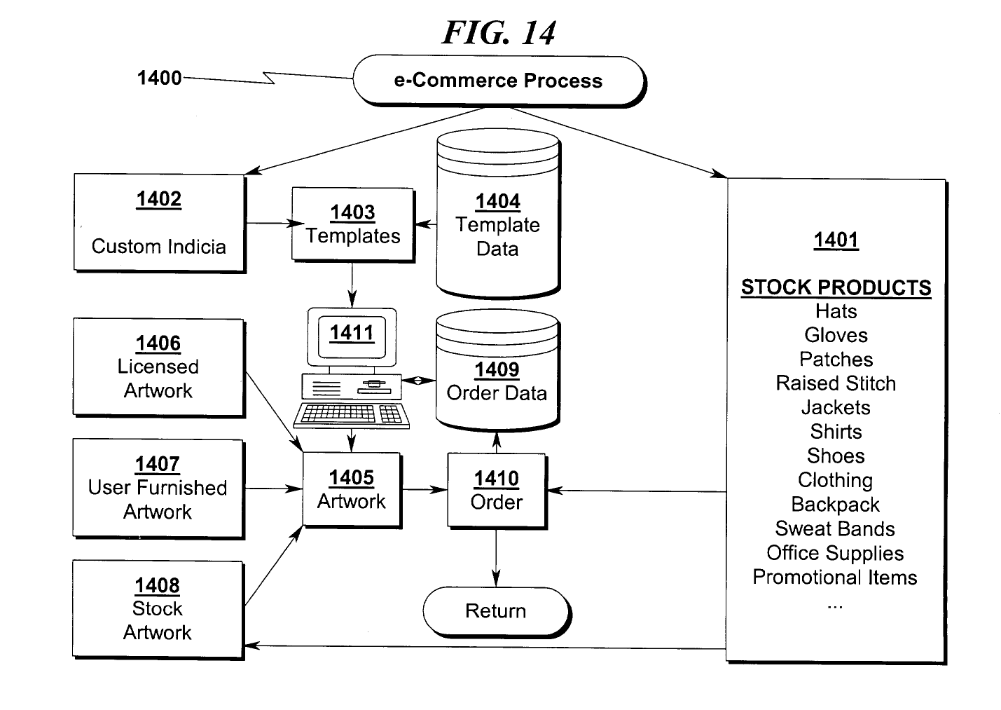

FIG. 13 (1300) illustrates a typical implementation of the disclosed indicia customer interface method. Here the process generally consists of the following data flows:
A computer interface (1301) interacts with website data (1302) and input from an indicia customer to generate order data (1303) describing the indicia to be generated.
Supporting this interface are welcome screens (1303), company information (1304), customer feedback (1305), and an e-commerce interface (1306).
The e-commerce interface (1306) is further detailed in FIG. 14 (1400), and may include support for stock products (1401) as well as custom indicia generation (1402).
Custom indicia generation (1402) generally starts with the use of a template (1403) that is filled with template data (1404) under control of a computer system (1411).
Order data describing the type of indicia to be fabricated (1409) is used by the computer (1411) in conjunction with the indicia template (1403) and associated template data (1404) to generate artwork (1405) that is used to complete the customer order (1410).
Artwork (1405) generated by the computer (1411) may have as its source licensed artwork (1406), user-furnished/defined artwork (1407), or stock artwork (1408). This versatility permits individualization of the indicia generated, as well as merging of stock art objects with licensed products. For example, it might be possible to associate a professional sports team with the picture of an amateur athlete, and merge the athlete's team with insignia of the sports team. This permits cross licensing of trademarks among athletes and sports teams. Additionally, this also permits linking of commercial sales external to the sports franchise with special promotions for the sports team.

One skilled in the art will realize that this method may be augmented with steps to affect a wide variety of artistic effects using the disclosed indicia display method.

### Exemplary Vendor/User Selection Methods (1500, 1600)

FIG. 15 (1500) illustrates a typical implementation of the disclosed indicia vendor selection method. This selection method involves selecting a target vendor for use with the created indicia, including but not limited to retail stores (1501), general advertising (1502), sports (1503) including amateur (1504) and professional (1505), general sales promotions (1506), entertainment (1507), and non-profit organizations (1508).

FIG. 16 (1600) illustrates a typical implementation of the disclosed indicia consumer selection method. This selection method involves selecting a target user for use with the created indicia, including but not limited to personal greetings (1611), military (1612), religious (1613), entertainment (1614), government campaigns (1615), security identification (1616), end-user applications (1617), wearability applications (1618), sales tools applications (1621), coupon applications (1622), fund raiser applications (1623), collectable/tradeable applications (1624), instructional applications (1625), promotions (1626), advertisement applications (1627), and commemorative events (1628).

One skilled in the art will no doubt recognize that both of these methods can be expanded to include other targets not specifically listed herein.

### Exemplary Indicia Output/Construction System (1700, 1800)

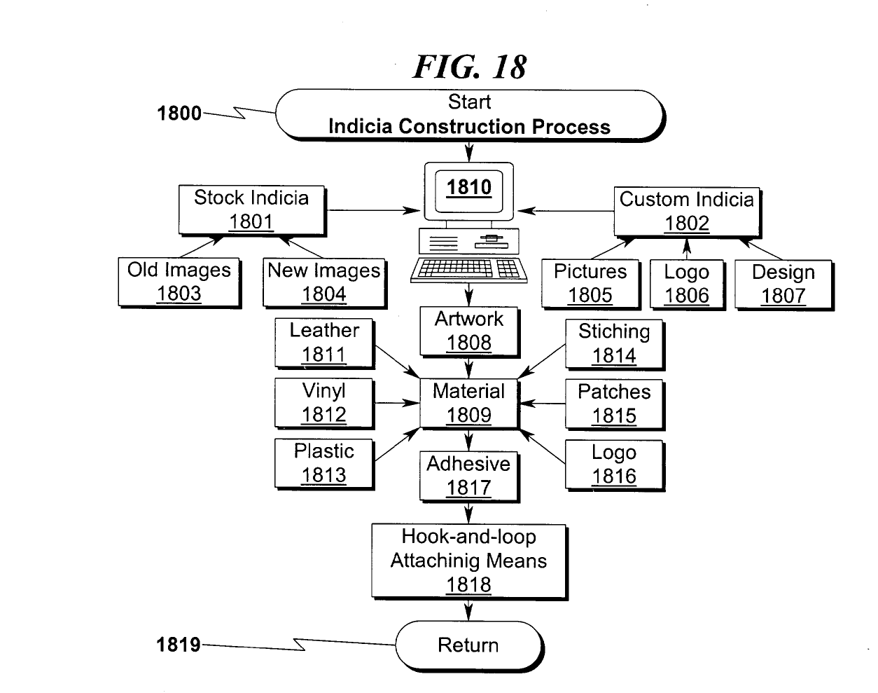

FIG. 17 (1700) and FIG. 18 (1800) illustrate a typical implementation of the disclosed indicia output system and process. FIG. 17 (1700) illustrates the output process under control of a computer system (1701) and illustrates this in the context of a flat surface printer (1702) and/or a raised stitch printer (1703).

This process is augmented by the indicia construction process/system (1711) detailed in FIG. 18 (1800). Here a computer controlled system (1810) selects either a stock indicia (1801) or custom indicia (1802) output. Stock indicia (1801) may integrate old (1803) or new (1804) images, and custom indicia may incorporate pictures (1805), logos (1806), and/or designs (1807) to form artwork (1808) for use with the finished material (1809).

The output material (1809) may be leather (1811), vinyl (1812), or plastic (1813), and may include stitching (1814), patches (1815), and/or logos (1816). The output material (1809) is then mated to hook-and-loop attaching means (1818) to form the finalized indicia.

### Exemplary Indicia Coupon System (1900)

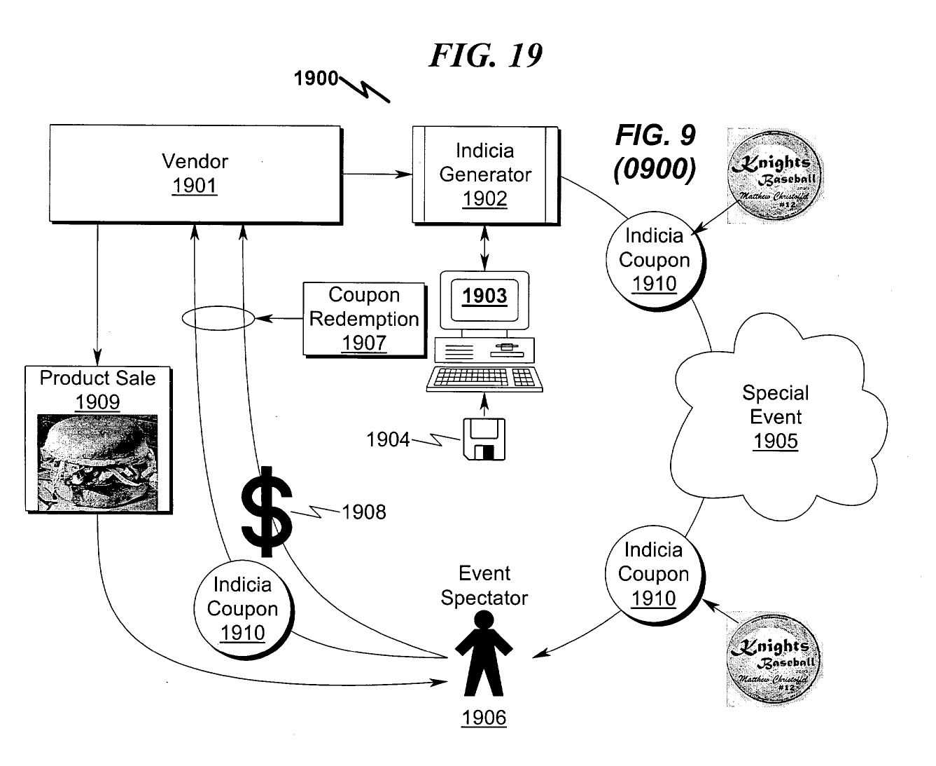

FIG. 19 (1900) illustrates a typical implementation of the disclosed indicia coupon redemption system. The application of the invention in this circumstance utilizes custom indicia as created by previously described indicia generation systems/methods as applied to a retail coupon generation system.

In this system (1900), a vendor (1901) interacts with an indicia generation system (1902) that is under computer control (1903) via the use of computer software (1904) to generate custom indicia (1910) for distribution at a special event (1905). These special events (1906) could be any event in which there are event spectators (1906), including but not limited to sporting events, entertainment events, concerts, and the like.

At the special event (1905), the indicia coupons (1910) are distributed to event spectators (1906). These spectators can then take the indicia coupons (1910) and redeem them (1907) with the vendor (1901) for products (1909). This redemption process (1907) may optionally include additional monies (1908) provided by the event spectator (1906) in addition to the indicia coupon (1910). Note here that there is a high likelihood that the event spectator (1906) will make additional purchases from the vendor (1901) at the time the coupon redemption process (1907) takes place, providing additional sales exposure for the vendor (1901) in this transaction. While FIG. 19 illustrates this system as applied to retail food service industries (1909), the disclosed system and method is not limited to this retail market, but encompasses any situation in which a vendor (1901) sells a product or service.

A significant benefit of this methodology as compared to the prior art is that the indicia generation system (1902, 1903, 1904) as described herein can produce custom indicia tailored to the individual event spectator (1906) and/or the particular special event (1905). For example, pictures of special event (1905) actors/participants can be merged with personalization information for each event spectator (1906). This markedly differs from traditional approaches to providing stock memorabilia for a given spectator event. The on-demand customizable aspect of the present invention permits a new dynamic in the sales/redemption aspect of traditional special event memorabilia. Additionally, the ability to customize the indicia coupon to the individual event spectator (1906) and/or special event (1905) permits the coupons to be collected as memorabilia as well as used for redemption future product sales (1909).

### Exemplary Indicia Coupon Method (2000)

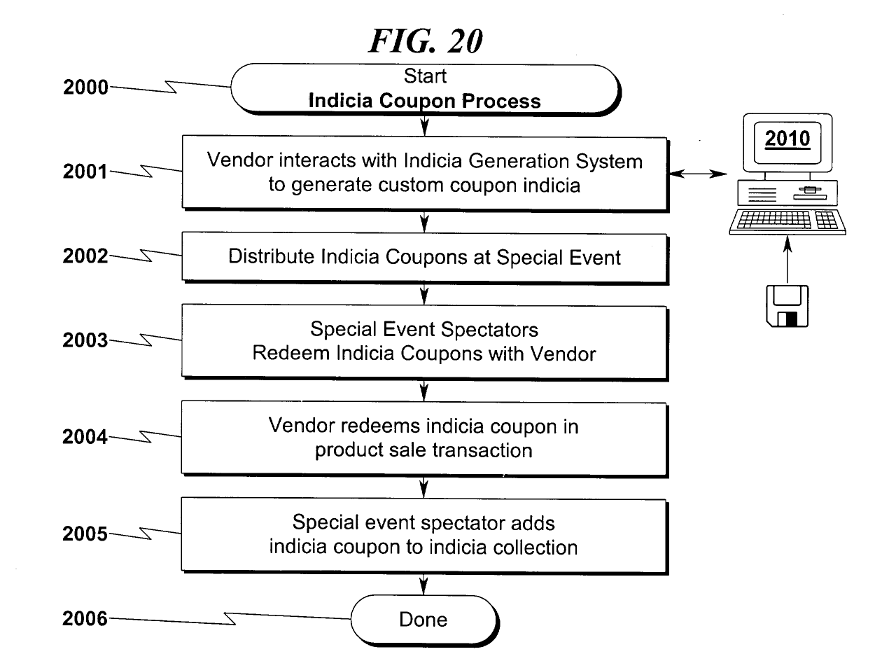

FIG. 20 (2000) illustrates a typical implementation of the disclosed indicia coupon redemption method used in conjunction with the system illustrated in FIG. 19 (1900). The general steps associated with this method include:
Vendor interaction with an Indicia Generation System to generate custom coupon indicia (2001).
Distribute the indicia coupons at a Special Event to event spectators (2002).
Redemption of indicia coupons with Vendor by the Special Event Spectators (2003).
Vendor redemption of the indicia coupon in a product sale transaction (2004).
Optional collection of the indicia coupon by the special event spectator (2005).

### Exemplary Indicia Registration System (2100)

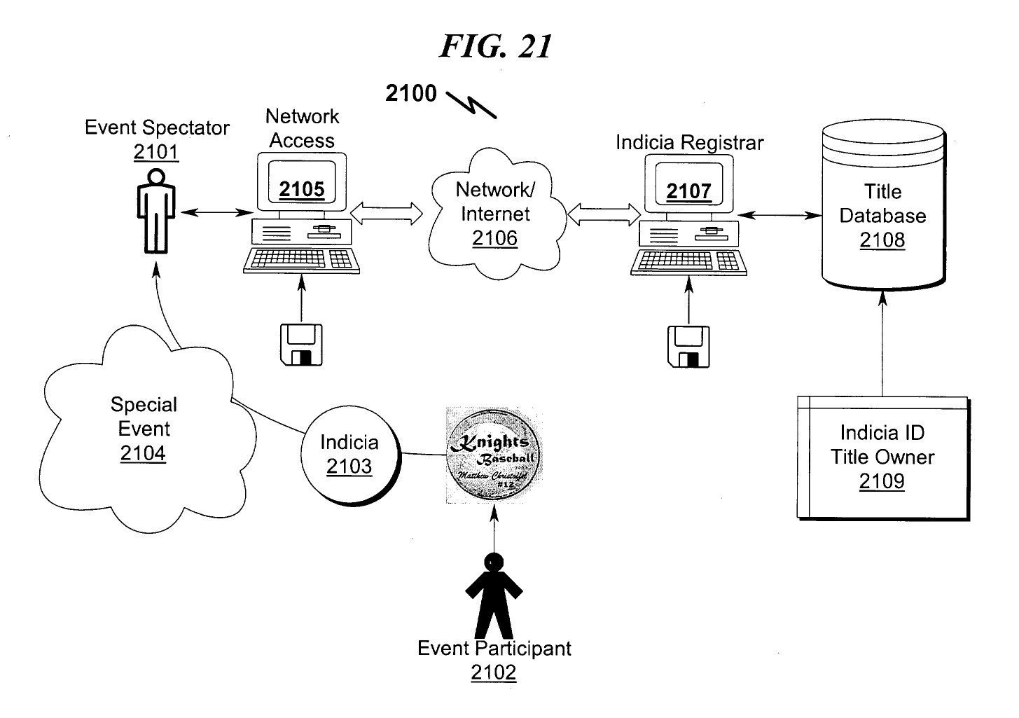

FIG. 21 (2100) illustrates a typical implementation of the disclosed indicia registration system. This system augments the indicia display process by providing a mechanism to permit authentication of display indicia as well as facilitating the trading of indicia.

As illustrated in FIG. 21, (2100), the general indicia registration/trading system begins with an event spectator (2101) that may interact with an event participant (2102) in which an event indicia (2103) associated with the special event (2104) is exchanged. This might include, for example, a professional athlete handing out custom indicia to fans at a sporting event in lieu of signing autographs. These indicia (2103) may even be custom identified as to the particular event, date, opposing team, or have a commemorative picture of the event participant (2102) and/or event spectator (2101). The scope of this customization is very wide, and permits a high degree of customization based on a given special event (2104) and/or event participant (2102).

After receiving the event indicia (2103), the event spectator (2101) then uses a network access device (2105) to communicate via a computer network/Internet (2106) to an indicia registration computer system (2107) that maintains a title database (2108) that registers the indicia identification and title owner (2109) of the event spectator (2101). This database (2108) may also have been preloaded by authority of the event participant (2102) to include serial numbers or other identification for each custom indicia (2103) distributed by the event participant (2102) at the special event (2104).

This disclosed system permits a wide variety of custom indicia (2103) to be registered as to the correct title owner and also to authenticate both the ownership and authenticity of the indicia. This system increases the value of the indicia by permitting limited run indicias to be generated and tracked as to both their origin and distribution. This title registration database (2108) also permits trading of indicia with high degree of confidence regarding both the ownership and authenticity of the indicia.

### Exemplary Indicia Trading System (2200)

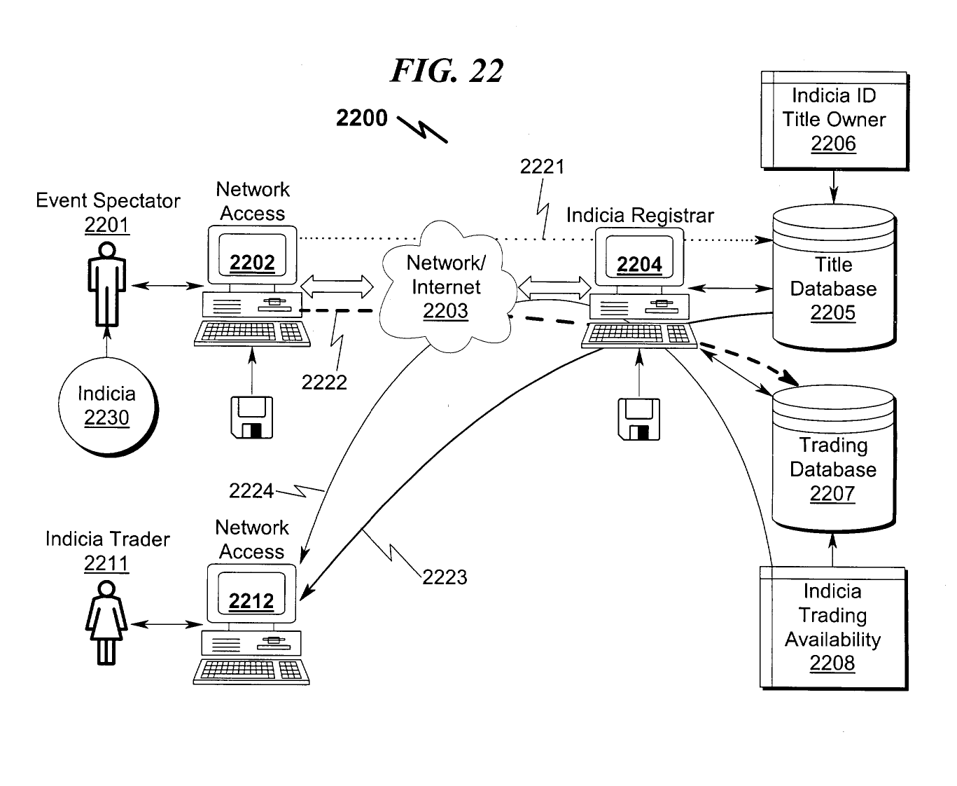

FIG. 22 (2200) illustrates one embodiment of the present invention as applied to an indicia trading system. This exemplary indicia embodiment augments the indicia display aspects of the present invention by permitting an event spectator (2201) to coordinate trades of indicia (2230) with an indicia trader (2211) using network access terminals (2202, 2212) across a network/Internet (2203).

This disclosed embodiment works in conjunction with the indicia registration system of FIG. 21 (2100) in that the even spectator (2201) may register an indicia (2230) via a transaction (2221) with an indicia registrar (2204) across a network/Internet. This registration transaction (2221) updates a title database (2205) containing indicia identification and title owner information (2206) relating to the event spectator (2201) and his/her associated indicia (2230). Additionally, during or after this registration transaction (2221), the event spectator may update a trading database (2222) to indicate that this particular indicia (2230) is available for trading (2208) to third party indicia traders (2211).

Indicia traders (2211) who desire to obtain a particular indicia (2230) may interrogate (2223) the title database (2205) to determine the ownership of a given indicia. This may be followed up by an interrogation (2224) of the trading database (2207) to determine whether the desired indicia (2230) is available for trading (2208). If the indicia is available for trading, the event spectator (2201) may be contacted to affect physical transfer of the indicia along with information necessary to update the title database (2205) to reflect the change in ownership to the indicia trader (2211) via modification of the indicia identification and title owner fields (2206) of the title database (2205).

The advantage of this system to both event spectators (2201) as well as indicia traders (2211) is that it permits widespread dissemination of information about available (and possible rare) indicia, as well as providing controls to protect against forgery, as well as tight controls governing both the ownership and sale of indicia. Many of the problems regarding the sales history and prior ownership of a given indicia can be solved by this disclosed system. Mere physical possession of a given indicia is insufficient to provide a certified sale absent proper registration of the indicia (along with proper serial codes) with the indicia registrar. Copies of a given indicia that are limited in number cannot be registered with the indicia registrar, and thus cannot be sold through this system. Buyers of indicia can be assured that certification information and tracking of previous owners of the indicia will prevent challenges to both ownership and authenticity of the particular indicia.

### Exemplary Indicia Trading System (2300)

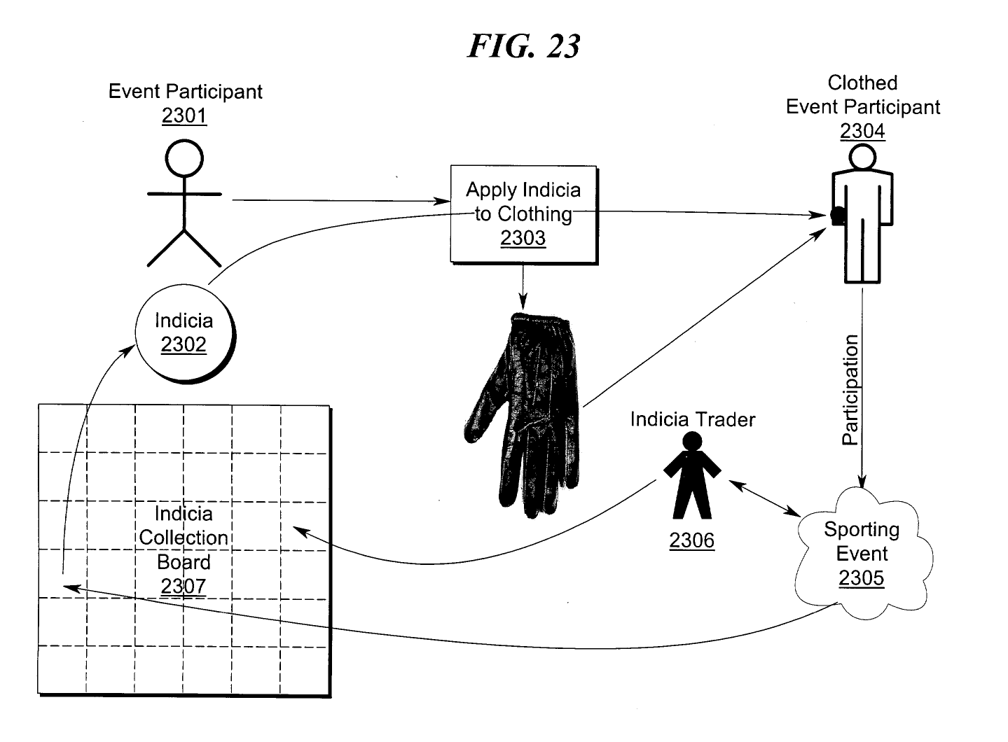

FIG. 23 (2300) illustrates one embodiment of the present invention as applied to an indicia trading system. This exemplary indicia embodiment permits an event participant (2301) to select an indicia (2302) that is then applied to sporting goods clothing (2303) that is work by the clothed event participant (2304) as he/she participates in the sporting event (2305).

At the sporting event (2305) the event participant (2304) may interact with an indicia trader (2306), trading indicia with this agent. Upon completion of the event, the event participant removes the indicia from the sporting goods clothing and optionally stores these indicia on an indicia collection board (2307). Note that this trading system permits a given event participant to change indicia during the sporting event at will, or trade for other indicia during the sporting event, in effect changing the “look” of the sports clothing being used in a very dynamic manner. This variability and flexibility is not possible with the prior art teachings.

Additionally, this system permits safe storage of indicia (2307) and the use of a variety of “tick-tack-toe” gaming regimes in which indicia are collected in groups to meet requirements for retail redemption promotions. For example, collections of indicia obtained at sporting events can be used to obtain discounts at fast food restaurants and the like, while still permitting team loyalty to be exercised, since the indicia collected may be worn on a variety of sports clothing. Note that a given indicia may be associated with a given sport (i.e., baseball) but worn on clothing associated with another sport (i.e., bowling).

### Exemplary Indicia Hat Embodiment (2400)

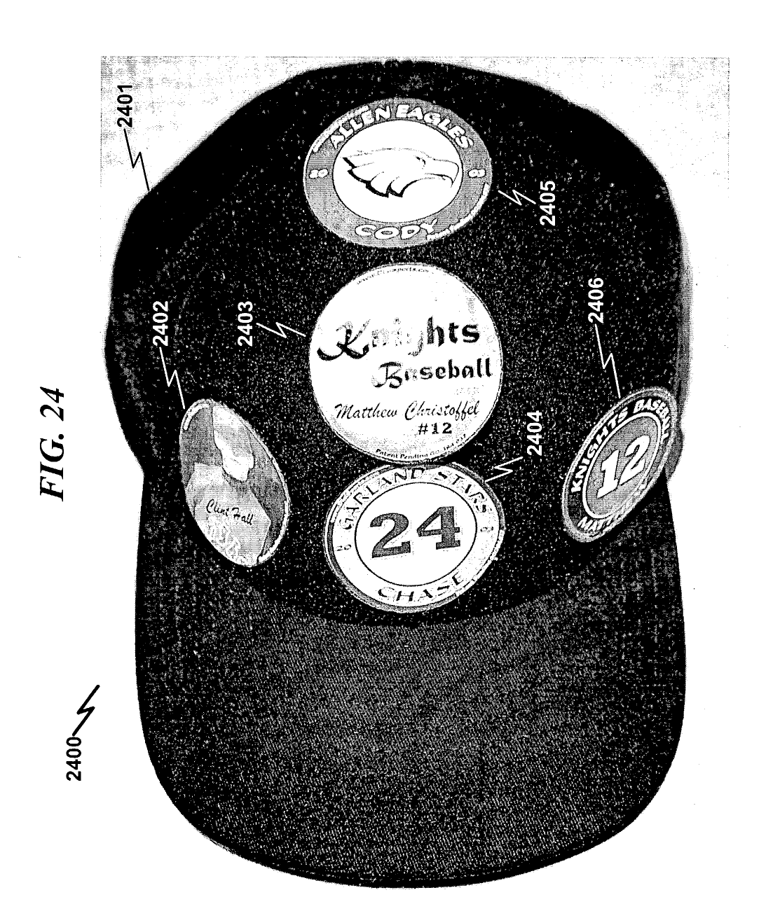

FIG. 24 (2400) illustrates one embodiment of the present invention as applied to an indicia display hat. The key difference between this clothing article and the prior art is that this clothing article is constructed of a material that permits the entire article surface (2401) to be a point of attachment for the custom indicia (2402, 2403, 2404, 2405, 2506). This eliminates the requirement in the prior art that the article be augmented with a loop material area for indicia attachment.

In this configuration, a typical indicia display hat may be constructed with the following materials:
6 PANELS—100% Polyester Tricot (with cotton buckram at 6 panels) (2401).
VISOR—100% Brushed Cotton Twill 108×56/16×12
BACK CLOSURE—100% Polyester Tricot strap with VELCRO® brand hook-and-loop fastener or equivalent
TOP BUTTON—100% Polyester Tricot
SWEATBAND—100% Cotton Twill 108×58/21×21 (w/foam)
INNER TAPE —100% Cotton Poplin 60×60/20×20

Note that the selection of a polyester tricot covering or an equivalent material that permits the “hook” of a hook-and-loop connection to mate permits the entire hat covering to operate as a mat for indicia display. This technique may also be used with gloves and other article clothing (see FIG. 10 (1001, 1002, 1003, 1004, 1005, 1006, 1007)) to permit application of indicia to a wide variety of locations on the clothing article.

### CONCLUSION

An indicia display system and method incorporating removable and reusable indicia constructed of flexible fabric and/or plastic has been disclosed. The present invention permits an indicia tag to be custom generated and then attached to a variety of indicia target displays by means of a non-metallic attaching means such as VELCRO® brand hook-and-loop fasteners or the like. This in conjunction with attaching means for each indicia target display permits a given indicia tag to migrate among various indicia target displays. This mobility permits a high degree of memorabilia migration and reuse while also permitting a safe environment for indicia to be uniquely generated to meet the needs of special events, sporting events, and the individual needs of sports athletes and their fans.

Although a preferred embodiment of the present invention has been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims:

1. An indicia display system comprising:
(a) a means for generating an indicia label;
(b) an indicia tag on which said indicia label is placed;
(c) one or more indicia target displays on which said indicia tag is attached via an attaching means;
wherein
said indicia tag is made of a non-metallic substance chosen from the group comprising fabric, plastic, or vinyl;
said attaching means comprises a two-piece non-metallic removable adhesive, one piece of which is attached to said indicia tag and one piece of which is attached to said indicia target display; and
said attaching means permits said indicia tag to be removed from said indicia target display for storage and/or attachment to a second indicia target display.

2. An indicia display fabrication method comprising:
(1) attaching a first piece of a two-piece adhesive means to an indicia tag having an indicia label;
(2) attaching a second piece of said two-piece adhesive means to an indicia target display;
(3) mating said first piece of said two-piece adhesive means to said second piece of said two-piece adhesive means thus affecting attachment of said indicia tag to said indicia target display;
wherein
said indicia tag is made of a non-metallic substance chosen from the group comprising fabric, plastic, or vinyl;
said attaching means comprises a two-piece non-metallic removable adhesive, one piece of which is attached to said indicia tag and one piece of which is attached to said indicia target display; and
said attaching means permits said indicia tag to be removed from said indicia target display for storage and/or attachment to a second indicia target display.

3. An indicia generation system comprising:
(a) indicia selection/design computer interface;
(b) consumer artwork/data;
(c) network/internet communication means;
(d) web host means;
(e) indicia templates;
(f) optional licensed artwork;
(g) indicia merging/output means;
(h) optional article integration means;
wherein
said indicia selection/design computer interface permits a consumer to create said consumer artwork/data describing an indicia to be generated;
said consumer artwork/data is transmitted via said network means to said web host means and merged with said indicia templates and said optional licensed artwork by said merging/output means, the result of said merging which is a custom indicia tailored to the requirements of said consumer;
said custom indicia is optionally attached to an article via said article integration means, the result being transferred to said consumer.

4. The indicia generation system of claim 3 wherein said system coordinates trading of indicia between two or more indicia traders using said network means.

5. The indicia generation system of claim 3 wherein said system coordinates trading of special events indicia between two or more indicia traders using said network means.

6. An indicia coupon generation/redemption system comprising:
(a) vendor;
(b) indicia generation means;
(c) indicia coupon;
(d) event spectator;
(e) product sale;
wherein
said vendor utilizes said indicia generation means to create said custom indicia for said special event;
said custom indicia is distributed to said event spectator at said special event;
said custom indicia is redeemable by said event spectator to said vendor to affect said product sale to said event spectator by said vendor;
said custom indicia is wearable by said event spectator before and/or after the time of said special event and/or said product sale by said vendor.

7. The indicia coupon generation/redemption system of claim 6 wherein said special event is a sporting event.

8. An indicia coupon generation/redemption method comprising:
(1) interaction between a vendor and an indicia generation system to generate custom indicia coupons;
(2) distributing said indicia coupons to event spectators at a special event;
(3) redemption by said spectators of said indicia coupons with said vendor;
(4) vendor redemption of said indicia coupons in a product sales transaction with said consumer;
(5) collection of said indicia by said spectators after said redemption process.

9. The indicia coupon generation/redemption method of claim 8 wherein said special event is a sporting event.

10. An indicia registration system comprising:
(a) network access means;
(b) network communication means;
(c) indicia registrar;
(d) title database;
wherein
said network access means permits an event spectator to communicate via said network communication means with said indicia registrar to update said title database to include the indicia identification and title owner of an indicia obtained from a special event and/or event participant.

11. An indicia trading system comprising:
(a) spectator network access means;
(b) network communication means;
(c) indicia registrar;
(d) title database;
(e) trading database;
(f) trader network access means;
wherein
said spectator network access means permits an event spectator to communicate via said network communication means with said indicia registrar to update said title database to include the indicia identification and title owner of an indicia obtained from a special event and/or event participant;
said trader network access means permits an indicia trader to communicate via said network communication means with said indicia registrar to determine the ownership of a given indicia via inspection of said title database, and the trading availability of said indicia via said trading database;
said indicia registrar coordinates the title transfer of indicia from said event spectator to said indicia trader by updating the contents of said title database and said trading database to reflect the title transfer from said event spectator to said indicia trader based on input from said event spectator to said spectator network access means.

12. An indicia trading system comprising:
(a) custom indicia means;
(b) target indicia clothing means;
(c) sporting event;
(d) optional indicia trader;
(e) indicia collection board;
wherein
said custom indicia means is applied to said target indicia clothing means by an event participant in said sporting event and said target indicia clothing means is worn by said event participant in said sporting event;
said optional indicia trader optionally trades with said event participant for said custom indicia means;
said event participant stores/displays said custom indicia on said indicia collection board.

13. A hat indicia display system comprising:
(a) a plethora of panels further comprising polyester tricot;
(b) a visor;
(c) a back closure comprising a hook-and-loop fastener;
(d) a top button comprising polyester tricot;
(e) a sweatband;
(f) inner tape;
wherein
said panels provide attachment means for custom generated indicia to be attached for display or removed/realigned at will.

14. The hat indicia display system of claim 13 wherein said panels further comprise cotton buckram at each panel.

15. The hat indicia display system of claim 13 wherein said visor further comprises brushed cotton twill.

16. The hat indicia display system of claim 13 wherein said visor further comprises polyester tricot.

17. The hat indicia display system of claim 13 wherein said back closure further comprises polyester tricot.

18. The hat indicia display system of claim 13 wherein said top button further comprises polyester tricot.

19. The hat indicia display system of claim 13 wherein said sweatband further comprises cotton twill.

20. The hat indicia display system of claim 13 wherein said inner tape further comprises cotton poplin.
